(19) United States
(12) Patent Application Publication
(10) Pub. No.: US 2019/0001785 A1
(43) Pub. Date: Jan. 3, 2019

(54) VEHICLE AIR CONDITIONER

(71) Applicant: MITSUBISHI HEAVY INDUSTRIES THERMAL SYSTEMS, LTD., Tokyo (JP)

(72) Inventor: Hideo SAHO, Tokyo (JP)

(73) Assignee: MITSUBISHI HEAVY INDUSTRIES THERMAL SYSTEMS, LTD., Tokyo (JP)

(21) Appl. No.: 16/067,856

(22) PCT Filed: Feb. 21, 2017
(86) PCT No.: PCT/JP2017/006434

§ 371 Date: Jul. 3, 2018

(30) Foreign Application Priority Data
Feb. 29, 2016 (JP) 2016-037680

(51) Int. Cl. B60H 1/00; B60H 1/32; B60H 1/34; B60H 1/24

(52) U.S. Cl. CPC B60H 1/00564; B60H 1/3227; B60H 2001/006; B60H 1/242; B60H 1/34

(57) ABSTRACT

The present invention enhances quietness in a passenger compartment of a vehicle by reducing the volume of refrigerant flowing noise emitted from an evaporator provided within a unit case. A vehicle air conditioner (1) includes a unit case (2) incorporated in a dashboard of a vehicle, an air flow path (3) formed in an interior of the unit case (2), an evaporator (4) provided inside the air flow path (3), and a connecting member (16A) configured to connect a portion of the evaporator (4) that is located near a central portion thereof in a surface direction to a structure (a front panel (2b)) of the unit case (2). The connecting member (16A) may be a biasing member that biases the portion of the evaporator (4) that is located near the central portion thereof in the surface direction in a direction orthogonal to a surface of the evaporator (4).

### TECHNICAL FIELD

The present invention relates to a vehicle air conditioner, and more particularly to a vehicle air conditioner designed to reduce refrigerant flowing noise that is emitted from an evaporator provided in an interior of an HVAC unit.

### BACKGROUND ART

An air conditioner or a so-called heating ventilation and air conditioning unit (HVAC unit) that is incorporated in a dashboard of a motor vehicle includes a resin molded unit case as disclosed in, for example, Patent Document 1. An air flow path is formed in an interior of the unit case, and an evaporator (an evaporating device), an air mixing damper, a heater core, and the like are provided sequentially in that order from an upstream side of the air flow path. These constituent elements are configured to cause temperature controlled air whose temperature is controlled by the constituent elements to be blown out selectively into a passenger compartment of the motor vehicle from any one of a face outlet flow path, a foot outlet flow path, and a defroster outlet flow path via a plurality of outlet mode switching dampers.

### CITATION LIST

### Patent Document

Patent Document 1: JP 2011-251556 A

### SUMMARY OF INVENTION

### Problem to be Solved by the Invention

Electric vehicles and hybrid vehicles have currently been getting popular. These vehicles have no engine or have engines, but the engines are not in operation in many occasions. This lowers the level of noise inside a passenger compartment when compared with engine-driven motor vehicles, resulting in a problem in that occupants tend to sense air conditioning noise emitted from an HVAC unit relatively louder.

The air conditioning noise includes blower noise, motor noise, opening and/or closing noise of various types of dampers, refrigerant flowing noise (evaporation noise) and the like. Among them, in particular, the refrigerant flowing noise (evaporation noise) is unique operation noise emitted from the evaporator sounding like hissing noise. This hissing noise is heard from an outlet of the HVAC unit every time a compressor, which operates intermittently during a cooling operation, is started up. Thus, there are a lot of users who are worried about this hissing noise, and countermeasures against the noise have been desired.

The invention has been made to solve the problem, and an object thereof is to provide a vehicle air conditioner that can reduce the volume of refrigerant flowing noise emitted from an evaporator that is provided within a unit case to thereby improve quietness inside a passenger compartment of a vehicle.

### Solution to Problem

The invention adopts the following configurations to solve the problem described above.

Namely, a vehicle air conditioner according to a first aspect of the present invention includes a unit case incorporated in a dashboard of a vehicle, an air flow path formed in an interior of the unit case, an evaporator provided in the air flow path, and a connecting member configured to connect a portion of the evaporator located near a central portion thereof in a surface direction to a structure of the unit case.

With the vehicle air conditioner configured in the way described above, the portion of the evaporator located near the central portion thereof in the surface direction is connected and fixed to the structure of the unit case by the connecting member in the interior of the unit case. This prevents the evaporator from vibrating in a direction (a thickness direction) orthogonal to the surface direction. Thus, the volume of refrigerant flowing noise emitted from the evaporator is reduced, which in turn makes it difficult for the refrigerant flowing noise to leak into a passenger compartment of the vehicle from outlets of the vehicle air conditioner, thereby making it possible to enhance the quietness inside the passenger compartment.

In the vehicle air conditioner configured in the way described above, the connecting member may be a biasing member configured to bias the portion of the evaporator located near the central portion thereof in the surface direction in a direction orthogonal to a surface of the evaporator.

In this way, the connecting member serves as a biasing member to thereby bias the portion of the evaporator located near the central portion thereof in the surface direction, thereby making it possible to apply a desired biasing force to the evaporator. This can prevent the evaporator from vibrating and suppress the refrigerant flowing noise emitted from the evaporator more effectively.

In addition, the use of another connecting member having a different biasing force allows the natural frequency of the evaporator to be changed, thereby making it possible to suppress the refrigerant flowing noise effectively with a setting that matches a condition under which the vehicle air conditioner is used.

In the vehicle air conditioner configured in the way described above, the structure may be an independent air conditioning bulkhead provided in a position close to the evaporator to divide the air flow path to a driver's seat side and a front passenger's seat side of the vehicle.

In this configuration, the connecting member connects the evaporator and the independent air conditioning bulkhead together to thereby prevent the evaporator from vibrating (resonating) in the thickness direction and suppress the emission of the refrigerant flowing noise from the evaporator.

In this way, one end of the connecting member having the other end connected to the evaporator is connected to the independent air conditioning bulkhead that is originally provided in the position close to the evaporator so as to prevent the evaporator from vibrating. This structure decreases the length of the connecting member to enhance the rigidity of the connecting member and effectively prevents the vibration of the evaporator. Thus, the vehicle air conditioner configured in the way described above can contribute to preventing the emission of refrigerant flowing noise from the evaporator.

A vehicle air conditioner according to a second aspect of the present invention includes a unit case incorporated in a dashboard of a vehicle, an air flow path formed in an interior of the unit case, an evaporator provided in the air flow path, and an air passage preventing member provided between a circumference of the evaporator and an inner surface of the unit case. The air passage preventing member is formed from a damping material capable of suppressing vibration of the evaporator.

With the vehicle air conditioner configured in the way described above, the vibration of the evaporator is damped by the air passage preventing member provided between the circumference of the evaporator and the inner surface of the unit case, which in turn reduces the volume of refrigerant flowing noise emitted from the evaporator.

The air passage preventing member is the member that is provided originally between the evaporator and the inner surface of the unit case, and only the material thereof is changed. Thus, the quietness of the evaporator can be improved without calling for an increase in production cost.

### Advantageous Effects of Invention

Thus, as has been described heretofore, with the vehicle air conditioner according to the present invention, the volume of refrigerant flowing noise emitted from the evaporator provided within the unit case can be reduced, thereby making it possible to enhance the quietness inside the passenger compartment of the vehicle.

### BRIEF DESCRIPTION OF DRAWINGS

FIG. 1 is a vertical cross-sectional view of a vehicle air conditioner according to a first embodiment of the present invention.

FIG. 2 is a horizontal cross-sectional view taken along a line II-II in FIG. 1.

FIG. 3 is a horizontal cross-sectional view illustrating a second embodiment of the present invention.

FIG. 4 is a vertical cross-sectional view of a vehicle air conditioner according to a third embodiment of the present invention.

FIG. 5 is a horizontal cross-sectional view taken along a line V-V in FIG. 4.

FIG. 6 is a vertical cross-sectional view of a vehicle air conditioner according to a fourth embodiment of the invention.

### DESCRIPTION OF EMBODIMENTS

Hereinafter, embodiments of the present invention will be described with reference to the drawings.

### First Embodiment

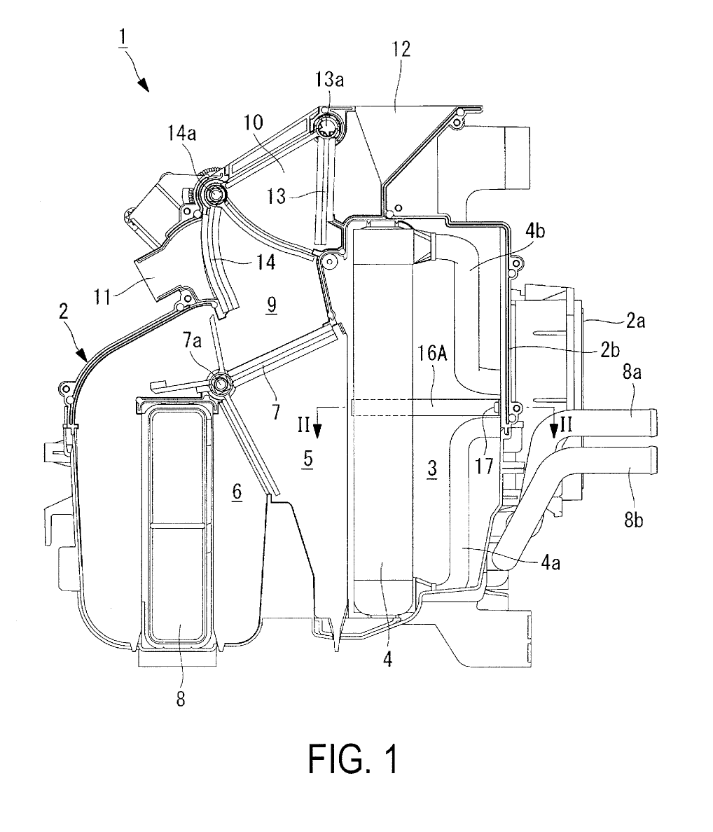

FIG. 1 is a vertical cross-sectional view of a vehicle air conditioner (an HVAC unit) according to a first embodiment of the present invention. In a front view of the drawing, a right side corresponds to a front of a vehicle, and a left side corresponds to a rear (a passenger compartment side) of the vehicle. This vehicle air conditioner 1 is incorporated in a dashboard of the vehicle, such as a motor vehicle, and includes a unit case 2 that is molded, for example, from a resin.

An air flow path 3 is formed in the unit case 2. This air flow path 3 converts an air flow sent from a blower unit, not illustrated, into an air flow in a front-back direction (a horizontal direction in FIG. 1), causing the air flow to pass toward a downstream side. An evaporator 4, making up a refrigeration cycle (not illustrated), is provided substantially vertical at an upstream location of the air flow path 3.

The air flow path 3 branches into a bypass flow path 5 and a heating flow path 6 at a location on a downstream side of the evaporator 4. An air mixing damper 7 is provided so as to rotate about a rotational shaft 7a at this branch portion, so that a flow rate ratio between an air flow directed to the bypass flow path 5 and an air flow directed to the heating flow path 6 can be controlled by a rotational position of the air mixing damper 7. A heater core 8 through which a coolant from engine coolant circuits 8a, 8b is circulated or a heating member such as a PTC heater that replaces the heater core 8 is provided substantially vertical in the heating flow path 6.

The bypass air flow path 5 and the heating flow path 6 merge together in an air mixing region 9 located downstream of the air mixing damper 7 and communicate with three outlet flow paths of a face outlet flow path 10, a foot outlet flow path 11, and a defroster outlet flow path 12. A defroster/face damper (an outlet mode switching damper) 13 is provided so as to rotate about a rotational shaft 13a between the face outlet flow path 10 and the defroster outlet flow path 12. Additionally, a foot damper (an outlet mode switching damper) 14 is provided so as to rotate about a rotational shaft 14a at an entrance of the foot outlet flow path 11.

The defroster/face damper 13 can rotate between a position where the face outlet flow path 10 is fully closed and a position where the defroster outlet flow path 12 is fully closed. On the other hand, the foot damper 14 can rotate between a position where the foot outlet flow path 11 is fully closed and a position where a flow path connecting to the face outlet flow path 10 and the defroster outlet flow path 12 is fully closed. The foot damper 14 and the defroster/face damper 13 are controlled individually to rotate to their respective positions in accordance with a desired outlet mode.

During a cooling operation, a liquid-phase highly pressurized refrigerant that is compressed by a refrigerant compressor, not illustrated, that is included in the refrigeration cycle and is further condensed by a condenser (a condensing device) is depressurized to a predetermined pressure by an expansion valve, not illustrated, that is accommodated in an expansion valve case 2a and thereafter flows from a high pressure refrigerant tube 4a into the evaporator 4. This refrigerant is evaporated (vaporized) in the evaporator 4 to take away the heat of the evaporator 4 to cool the evaporator 4 and thereafter returns to the refrigerant compressor from a low pressure refrigerant tube 4b.

An air flow from the blower unit, not illustrated, into the air flow path 3 passes through the evaporator 4 that is cooled by the heat of vaporization of the refrigerant as described above to thereby be cooled and is distributed into the bypass flow path 5 and the heating flow path 6 at a distribution ratio corresponding to a rotational position of the air mixing damper 7. The cooled air that flows into the heating flow path 6 is heated by the heater core 8, merges with the cooled air that flows through the bypass flow path 5 in the air mixing region 9, and is thereafter blown out into the passenger compartment through the outlet flow paths 10, 11, 12 for use in air conditioning.

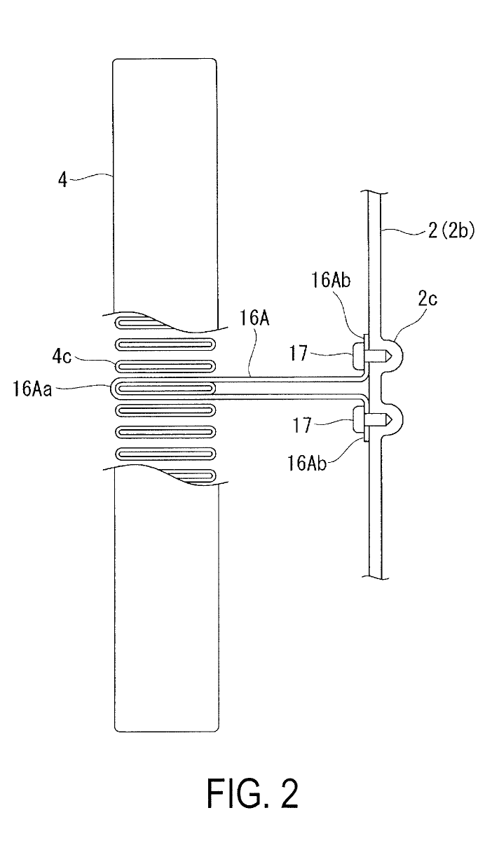

To suppress refrigerant flowing noise (vaporization noise) that is generated when the refrigerant is vaporized in the evaporator 4, a bracket 16A (a connecting member) is provided that connects a portion of the evaporator 4 that is located near a central portion thereof in a surface direction to a structure of the unit case 2, for example, a front panel 2b thereof. As illustrated in FIG. 2, too, this bracket 16A is formed, for example, of a strip of metallic plate and is then bent into a U-like shape to have a U-turn portion 16Aa and a pair of fastening pieces 16Ab.

The U-turn portion 16Aa of the bracket 16A is wound round one of a number of tubes 4c that is located near the central portion of the evaporator 4 in the surface direction, the tubes 4c making up the evaporator 4. This U-turn portion 16Aa is prevented from moving relative to the tube 4c. For example, the tube 4c is held in the U-turn portion 16Aa so as to be pressed thereagainst. Alternatively, the U-turn portion 16Aa and the tube 4c are bonded or welded together so as not to move relative to each other. Additionally, the fastening pieces 16Ab of the bracket 16A are fastened to their respective fastening bosses 2c formed on the front panel 2b of the unit case 2 with machine screws 17.

The material and shape of the bracket 16A and the connecting structure of the bracket 16A to the portion of the evaporator 4 that is located near the central portion thereof in the surface direction are not limited to the structure described above. For example, a projecting portion having the same function as that of the bracket 16A may be formed integrally on the front panel 2b of the unit case 2.

With the vehicle air conditioner 1 configured in the way described heretofore, the portion of the evaporator 4 that is located near the central portion thereof in the surface direction is connected and fixed to the front panel 2b of the unit case 2 by the bracket 16A in the unit case 2. This prevents the evaporator 4 from vibrating in the direction (the thickness direction) orthogonal to the surface direction. Consequently, the volume of refrigerant flowing noise emitted from the evaporator 4 is reduced, which in turn makes it difficult for the refrigerant flowing noise to leak into the passenger compartment of the vehicle from the outlet flow paths 10, 11, 12 of the vehicle air conditioner 1, thereby making it possible to enhance the quietness in the passenger compartment.

### Second Embodiment

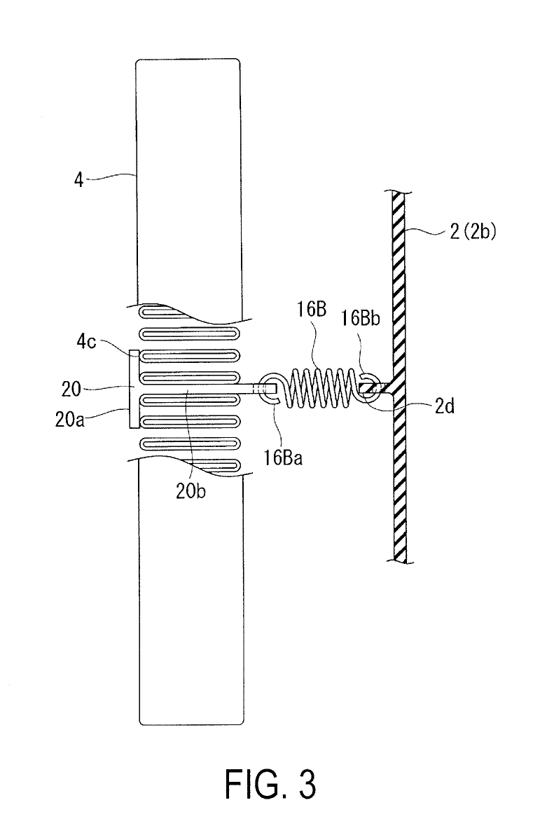

FIG. 3 is a horizontal cross-sectional view illustrating a second embodiment of the present invention. FIG. 3 is a horizontal cross-sectional view illustrating the same position as the position in the first embodiment that is illustrated in FIG. 2.

In this second embodiment, a spring 16B is used as a connecting member that connects a portion of an evaporator 4 that is located near a central portion thereof in a surface direction to a front panel 2b of a unit case 2. This spring 16B is a tension spring in which hooks 16Ba, 16Bb are formed at ends of a coil portion thereof.

For example, a tension member 20, which is formed substantially into a T-shape when seen from a top thereof, is inserted between two adjacent tubes 4c that are positioned near the central portion of the evaporator 4 in the surface direction from a rear (a passenger compartment side). This tension member 20 is formed from a resin or metal and includes a contact piece 20a that is brought into contact with a plurality of tubes 4c of the evaporator 4 and an insertion piece 20b that extends forward from a middle portion of the contact piece 20a in a width direction thereof to be inserted between the two tubes 4c.

The hook 16Ba of the spring 16B is hooked in a hooking hole at a rear end of the insertion piece 20b of the tension member 20, while the other hook 16Bb is hooked in a hooking hole in a hooking piece 2d that is formed on the front panel 2b of the unit case 2. The length and tensile force of the spring 16B are set in advance so that the spring 16B is stretched by a predetermined tensile force when the hooks 16Ba, 16Bb at the ends of the spring 16B are hooked in the way described above.

In this way, a biasing member like the spring 16B is used as the connecting member to bias the portion of the evaporator 4 that is located near the central portion thereof in the surface direction toward the front panel 2b, thereby making it possible to apply a desired biasing force to the evaporator 4. This can prevent the evaporator 4 from vibrating to thereby suppress refrigerant flowing noise emitted from the evaporator 4 effectively.

In addition, the use of another spring 16B having a different biasing force allows the natural frequency of the evaporator 4 to be changed. This can suppress the refrigerant flowing noise effectively with a setting that matches a condition (for example, a type and pressure of a refrigerant, a type of a vehicle, and the like) under which the vehicle air conditioner 1 is used.

It should be noted that the connecting member is not limited to the spring 16B, and hence, the spring 16B may be replaced with a band formed from an elastic material such as rubber. In short, any member may be adopted, provided that the member provides a tensile force acting between the portion of the evaporator 4 that is located near the central portion thereof in the surface direction and the front panel 2b of the unit case 2. Alternatively, a member that pushes the portion of the evaporator 4 that is located near the central portion thereof in the surface direction and the front panel 2b of the unit case 2 so as to expand a space therebetween may be used as the connecting member. For example, a block formed from an elastic material may elastically be installed between the evaporator 4 and the front panel 2b of the unit case 2.

### Third Embodiment

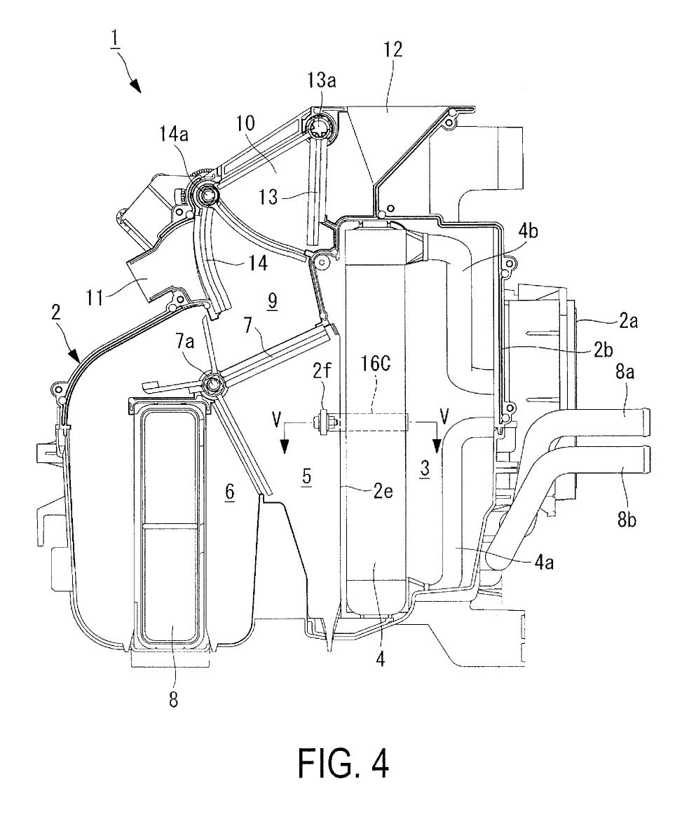

FIG. 4 is a vertical cross-sectional view of a vehicle air conditioner 1 according to a third embodiment of the present invention. The third embodiment differs from the first embodiment illustrated in FIG. 1 only in the configuration of a peripheral area of a bracket 16c that functions as a connecting member that connects a portion of an evaporator 4 that is located near a central portion thereof in a surface direction to a structure of a unit case 2 with the configuration of the remaining portion of the third embodiment left unchanged from that of the first embodiment. Thus, like reference numerals will be given to portions having like configurations to those of the first embodiment, so that the repetition of similar descriptions can be omitted.

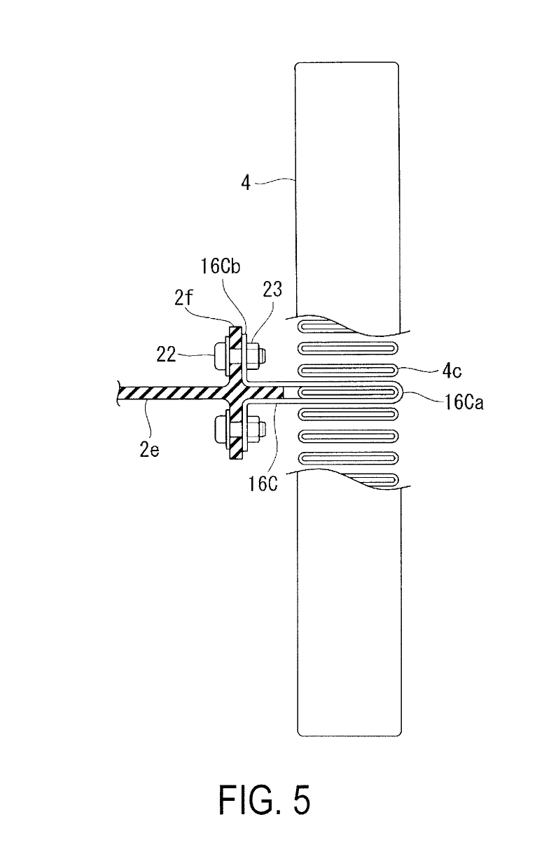

As illustrated in FIG. 5, the bracket 16C that is provided near the central portion of the evaporator 4 in the surface direction is formed substantially into a U-shape when seen from a top thereof that is almost similar to the bracket 16A (refer to FIG. 2) of the first embodiment and includes a U-turn portion 16Ca and a pair of fastening pieces 16Cb. The U-turn portion 16Ca is wound round one of a number of tubes 4c, the tubes 4c making up the evaporator 4, that is located near the central portion of the evaporator 4 in the surface direction, which prevents U-turn portion 16Ca from moving relative to the tube 4c.

An independent air conditioning bulkhead 2e is used as the structure of the unit case 2 to which the pair of fastening pieces 16Cb of the bracket 16C are fastened. This independent air conditioning bulkhead 2e is provided in a position close to the evaporator 4 to divide an air flow path 3 (5, 6) into a driver's seat side and a front passenger's seat side of a vehicle. This independent air conditioning bulkhead 2e is also illustrated in FIG. 1 illustrating the first embodiment (without a reference numeral).

As illustrated in FIG. 5, the independent air conditioning bulkhead 2e is formed into a vertically-extending plate shape and is formed integrally, for example, on an inner surface of the unit case 2. A pair of fastening pieces 2f projecting to the left and right in a vehicle-width direction are formed near an edge portion of the independent air conditioning bulkhead 2e adjacent to the evaporator 4. Then, the pair of fastening pieces 16Cb of the bracket 16C are superposed on the pair of fastening pieces 2f and fastened together with machine screws 22 and nuts 23.

The configuration described above enables the bracket 16C to connect the portion of the evaporator 4 that is located near the central portion thereof in the surface direction and the independent air conditioning bulkhead 2e together. This enables the bracket 16C to prevent the evaporator 4 from vibrating or resonating in a thickness direction of the evaporator 4, which in turn suppresses the emission of refrigerant flowing noise from the evaporator 4.

In this way, one end of the bracket 16C having the other end connected to the evaporator 4 is connected to the independent air conditioning bulkhead 2e that is originally provided in the position close to the evaporator 4 so as to prevent the evaporator 4 from vibrating. This structure decreases the length of the bracket 16C to enhance the rigidity of the bracket 16C and effectively prevents the vibration of the evaporator 4. Thus, the vehicle air conditioner 1 configured in the way described above can contribute to preventing the emission of refrigerant flowing noise from the evaporator 4.

### Fourth Embodiment

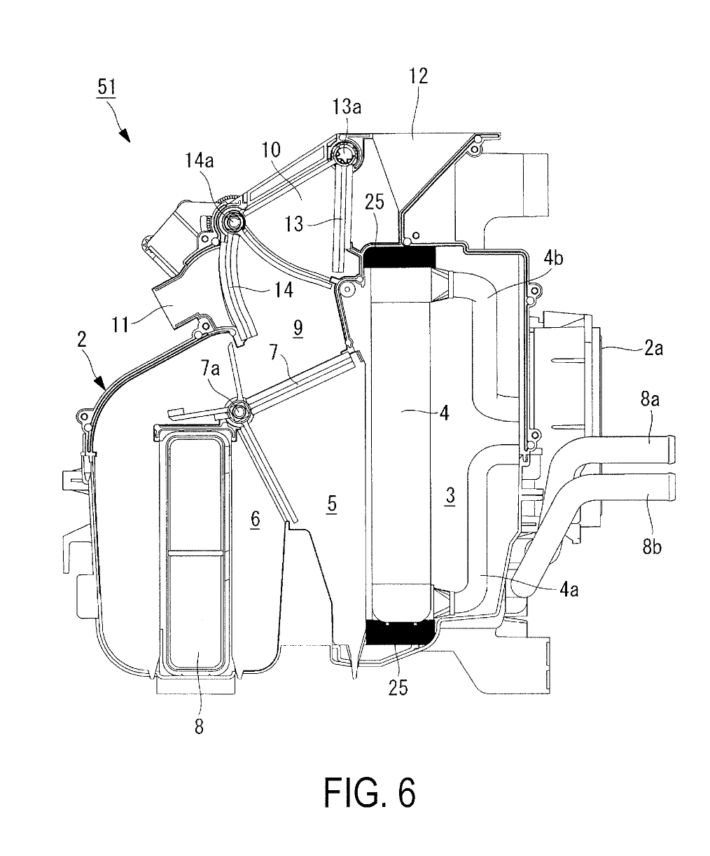

FIG. 6 is a vertical cross-sectional view of a vehicle air conditioner 51 according to a fourth embodiment of the present invention. This vehicle air conditioner 51 differs from the vehicle air conditioner 1 of the first embodiment illustrated in FIG. 1 only in a type of material of an air passage preventing member 25 that is provided so as to surround an evaporator 4 with the configuration of the remaining portion of the fourth embodiment left unchanged from that of the first embodiment. Thus, like reference numerals will be given to portions having like configurations to those of the first embodiment, so that the repetition of similar descriptions can be omitted.

Although omitted in FIGS. 1 and 4, the air passage preventing member 25 is interposed between a circumference of the evaporator 4 and an inner surface of a unit case 2. This air passage preventing member 25 is an airtight member for preventing a reduction in air conditioning efficiency that is caused by a passage of air lying on an upstream side of the evaporator 4 through between the unit case 2 and the evaporator 4. In general, a low density urethane sponge or the like is used as a material for the air passage preventing member 25. In this embodiment, however, a damping material such as higher-density butyl rubber or silicone rubber is used as a material for the air passage preventing member 25. Using such a damping material can suppress the vibration of the evaporator 4 in an interior of the unit case 2.

With the vehicle air conditioner 51 configured in the way described above, the vibration of the evaporator 4 is damped by the air passage preventing member 25 that is provided between the circumference of the evaporator 4 and the inner surface of the unit case 2, which in turn reduces the volume of refrigerant flowing noise emitted from the evaporator 4.

The air passage preventing member 25 is the member that is originally provided between the evaporator 4 and the inner surface of the unit case 2. Thus, the quietness of the evaporator 4 can be improved only by changing materials for the air passage preventing member 25 without calling for an increase in production cost.

Thus, as has been described heretofore, according to the embodiments, the volume of refrigerant flowing noise emitted from the evaporator 4 provided within the unit case 2 can be reduced to thereby enhance the quietness within the passenger compartment of the vehicle by the simple, light and inexpensive configuration.

Note that the present invention is not limited only to the configurations of the above-described embodiments, and changes or modifications may be made as appropriate without departing from the spirit of the present invention. Embodiments having such changes or modifications are included in the scope of claims of the present invention.

For example, the internal structure (layout or the like) of the unit case 2, the relative positional relationship between the evaporator 4 and the heater core 8, and the air flow paths 3, 5, 6, 9 and the like and further the relative positional relationship between the dampers 7, 13, 14 and the outlet flow paths 10, 11, 12 are not limited to the aspects of the embodiments, and hence, other structures may be adopted.

### REFERENCE SIGNS LIST

1 Vehicle air conditioner

2 Unit case

2b Front panel (Structure of unit case)

2e Independent air conditioning bulkhead (Structure of unit case)

3 Air flow path

4 Evaporator

4c Tube

16A Bracket (Connecting member)

16B Spring (Connecting member)

16C Bracket (Connecting member)

20 Tension member

25 Air passage preventing member

1-4. (canceled)

5. A vehicle air conditioner comprising:
a unit case incorporated in a dashboard of a vehicle;
an air flow path formed in an interior of the unit case;
an evaporator provided in the air flow path; and
a connecting member configured to connect a portion of the evaporator located near a central portion thereof in a surface direction to a structure of the unit case.

6. The vehicle air conditioner according to claim 5, wherein
the connecting member is a biasing member configured to bias the portion of the evaporator located near the central portion thereof in the surface direction in a direction orthogonal to a surface of the evaporator.

7. The vehicle air conditioner according to claim 5, wherein
the structure is an independent air conditioning bulkhead provided in a position close to the evaporator to divide the air flow path to a driver's seat side and a front passenger's seat side of the vehicle.

8. The vehicle air conditioner according to claim 6, wherein
the structure is an independent air conditioning bulkhead provided in a position close to the evaporator to divide the air flow path to a driver's seat side and a front passenger's seat side of the vehicle.
